(19) United States
(12) Patent Application Publication
(10) Pub. No.: US 2006/0138383 A1
(43) Pub. Date: Jun. 29, 2006

(54) Heat-transfer medium and methods of making and using the same

(75) Inventor: Shaofu Ming, Heilongjiang Province (CN)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: New World ZGM Limited, Road Town (VG)

(21) Appl. No.: 11/357,977

(22) Filed: Feb. 22, 2006

Related U.S. Application Data
(62) Division of application No. 10/877,866, filed on Jun. 25, 2004.

(30) Foreign Application Priority Data
Feb. 12, 2004 (CN) CN 200410003982.6

(51) Int. Cl. C09K 5/00

(52) U.S. Cl. 252/71

(57) ABSTRACT

The present invention relates to a heat-transfer medium having an aqueous solution of one or more kinds of salts wherein at least one kind of salt is selected from the group of coordination compounds formed between one or more metallic ions of copper, silver, gold, nickel, chromium, zinc and cobalt, and organic or inorganic acid. The coordination compounds can optionally contain ammonia. The pH of the heat-transfer medium can be from 6 to 10, preferably is 7. The present invention also relates a method for preparing the heat-transfer medium and its application in heat-transfer equipment.

This is a divisional of co-pending U.S. patent application Ser. No. 10/877,866, filed Jun. 25, 2004, which is hereby incorporate herein by reference.

### TECHNICAL FIELD

The present invention generally relates to a heat-transfer medium, and particularly relates to a heat-transfer medium comprising aqueous solution of compounded inorganic salts. The present invention also relates to a method of making and using the heat-transfer medium.

### TECHNICAL BACKGROUND

In the field of heat production, the most widely used heat-transfer medium is water and/or water vapor. In other practice, oils or some kinds of gases can be used as heat-transfer medium. Gases have much less thermal conductivity and much lower thermal efficiency. Although oils have slightly higher thermal conductivity, they need huge and various heat-production equipment, which greatly increases costs and makes them unsuitable for wider applications. Although aqueous media are most widely used, they have low heat conductivity to absorb heat completely.

In addition, there often exist impurities in aqueous media which can cause scale incrustation that can erode metallic pipelines. In particular, once formed, scale incrustation will severely affect heat-transfer. Therefore, a great deal of work has been done in cleaning scale and in anti-erosion. Some patents, such as CN1038693, CN1066432, CN1160684, CN1293153, CN1349940, CN1442375, as well as JP59-173192 etc., discuss cleaning of scale incrustation or anticorrosion by way of adding substances such as phosphate or meta-phosphate and humic acid as well as amines or ammonium salts. But none of these patents concern works on heat-transfer media or give any suggestion to use compounded inorganic salts, in particular salt solution containing coordination compound for enhancing thermal conductivity of aqueous media.

When using convection heat-exchange which is formed by the flowing of water or oil in pipeline, there will be relatively lower thermal efficiency. When using the potent latent heat of evaporation which cost during phase transition, thermal efficiency in condensation process can be greatly increased, coupled with convection heat-exchange.

The present inventor filed in 1990 two patent applications, one of which, CN1048752 disclosed a thermal medium employing a mixture comprising potassium dichromate, potassium sulfate, distilled water and ethanol in a ratio of 1:0.05:8:0.95. The present invention provides an environment-friendly, in-corrosive and energy-economic heat-transfer medium which has great latent heat of evaporation, high thermal conductivity, desired heat-transfer effect.

### SUMMARY OF THE INVENTION

Therefore, it is an object of the present invention to provide a medium which is suitable for heat-transfer and heat-exchange in closed system by phase transition in order to enhance thermal conductivity and thermal exchange thus to save energy high-effectively and environment-friendly.

It is another object of the present invention to provide an in-corrosive heat-transfer medium which has great latent heat of evaporation and improved thermal conductivity.

The heat-transfer medium of the present invention comprises an aqueous solution of one or more kinds of salt(s) wherein at least one kind of salt is selected from the group of coordination compounds formed between one or more metallic ions of copper, silver, gold, nickel, chromium, zinc and cobalt, and organic or inorganic acid. The coordination compounds can optionally contain ammonia. The pH of the heat-transfer medium is from 6 to 10, preferably is 7.

The heat-transfer medium of the present invention further comprises a salt of inorganic and/or organic acid with alkali or alkaline metal so as to further improve the property of the medium and eliminate foreign smells.

The inorganic acid includes hydrochloric, sulfuric, phosphoric, nitric acid or any combination thereof, of which, hydrochloric and/or phosphoric acid is preferable. The organic acid includes humic acid, substituted or unsubstituted, mono-carboxylic or poly-carboxylic acid having 1 to 6 carbon atoms, preferably those having one or more hydroxyl and/or carboxyl substituents, such as formic acid, acetic acid, propanetrioic acid, oxalic acid, citric acid, succinic acid, malonic acid, succinic acid substituted by hydroxyl, hydroxy-pentanetrioic acid or a mixture thereof, preferably humic acid.

Another object of the present invention is to provide a method for preparing a heat-transfer medium, comprising dissolving one or more salts in water to form a coordination compounds between metallic ions selected from copper, silver, gold, nickel, chromium, zinc and cobalt, and organic or inorganic acid. The coordination compounds can optionally contain ammonia; then pH of the heat-transfer medium is adjusted to range from about 6 to about 10, preferably to 7. In the case of multiple salts, inorganic or organic salts are first dissolved. Optionally ammonium or humic acid is dissolved to form complex. The pH is adjusted to 6-10, preferably to 7. Typically, sodium hydroxide or potassium hydroxide or ammonium hydroxide is used to adjust pH. If is necessary to use acid, hydrochloric and/or phosphoric acid can be used.

A further object of the present invention is to provide use of the heat-transfer medium according to present invention. The said medium can be used to transfer heat in any apparatus using liquid as a heat-transfer medium, such as used in the field of heat production, house heating, vehicle heating, drying operation industry, various heat-transfers, heat-exchangers, showers, hot-air screen, solar energy equipment and residual heat utilizing devices and like.

A further object of the present invention is to provide a heat-transfer equipment which employs the heat-transfer medium according to the present invention.

The present inventor found that certain chemically composite heat-transfer media containing coordination compound have high latent heat of evaporation and high thermal conductivity. The present inventor has done a lot of tests in selecting and combining a variety of salts of inorganic and organic acids. Additionally or alternatively, heat-transfer media have to have good stability and high speed of heat conductivity at operation temperature and pressure, and can bear coldness in chilling environment. It is greatly advantageous and profitable to use the heat-transfer medium of present invention in heat-production system.

Before a salt is added into water, it is preferred to dissolve the salt completely to facilitate vaporization. The heat-transfer medium of present invention can be dissolved such as to form a kind of salt solution. The present inventor originally found that adding metallic salt to water could enhance heat conductivity. But the addition of salt can bring about two problems, i.e., some salts have low solubility and others are corrosive. The present inventor found that the two problems can be resolved by addition of complex.

In order to increase heat conductivity, one or more metallic salts, such as a salt of copper, silver, gold, nickel, chromium, zinc, cobalt or a mixture of them, can be added. Among these metallic salts, some have low solubility and can be made into complex so as to obtain a solution. To ensure the stability of the heat-transfer medium under operation conditions and also to ensure the heat-transfer medium to be chemically neutral, other salts can be added, such as a salt of an inorganic or organic acid with an alkali or alkaline metal. The inorganic acid includes hydrochloride, sulfuric acid, nitric acid, phosphoric acid or any mixture thereof, preferably hydrochloride and/or phosphoric acid since phosphoric acid also has an effect of protecting pipelines from corrosion. An alkali or alkaline metal ion is preferably cation of potassium, sodium, calcium, magnesium, aluminum, zinc or their mixture and the like, and particularly preferably is ammonium cation since ammonium cation can form a complex with metallic ion such as copper or chromium.

The organic acid includes humic acid, substituted or un-substituted, mono-carboxylic or poly-carboxylic acid having 1 to 6 carbon atoms, preferably those having one or more hydroxyl and/or carboxyl substituents, such as formic acid, acetic acid, propanetrioic acid, oxalic acid, citric acid, succinic acid, malonic acid, hydoxyl-substituted acid, succinic acid, hydroxy-pentanetrioic acid or any mixture thereof, preferably humic acid. Certainly, aromatic carboxylic acids, such as hydroxy-benzoic acid, can also be used.

Although organic acids can produce peculiar smells and are hardly used, we have unexpectedly found that a specific organic acid, i.e., humic acid is particularly suitable. Therefore, humic acid is preferably added to the medium of present invention. Not limited by any special theory, we believe that humic acid is a substance with macromolecular structure, being weak in acidicidity and that its chemical property and complexing ability (adsorptivity) depend on several active groups such as carboxyl, hydroxyl etc in the molecular structure. The humic acid (HA) molecule can form porous polymer similar to grape bunch by association with acidic medium or by the action of neutral salt with valence of more than two, hence endow it with large specific area. It has strong electrostatic attraction and high ion-exchange capability and can complex with heavy metal, alkali or alkaline ions to form coordination compound. Its complexing ability (adsorptivity) fit in with Langmuir equation, such as the isotherm equation for HA adsorbing Cd²⁺ shown as below:
G=C/(0.01C+0.09)
wherein G is the number of milligram equivalent Cd²⁺ removed by a gram of HA, C is the concentration of Cd²⁺ in balance counted in mg/L.

The salt in the present heat-transfer medium can also form complexes, such as K₂[Co(SO₄)₂] or K₂SO₄.Al₂(SO₄)₃.24H₂O and the like.

The amount of salt can vary. In an exemplary embodiment, the salt amount can be at most 40% by weight depending on the user's requirement. In another exemplary embodiment, the salt amount can be no lower than 0.5% by weight. When the amount is too low for example lower than 0.5% by weight, it is not easy to increase heat conductivity. When the amount is higher than 40% by weight, it is not easy to eliminate erosion. When the amount is too high, the latent heat of evaporation will adversely reduce. The amount of salt is preferably 1 to 25% by weight, more preferably 2 to 15% by weight.

The selection of species and amounts of salts can depend on the application requirements of customers, such as the starting temperature, the heat-transfer rate, the size of the latent heat of evaporation, the anti-erosion property of equipment. Various species and amounts of salts can be added to meet the application requirements.

The present heat-transfer medium is easily prepared, generally by dissolving chemicals sold in the market. There is no limitation to the temperature at which chemicals are dissolved, but heating can increase dissolution. In an exemplary embodiment, the dissolving temperature is 20 to 80° C. There is also no limitation to the order of dissolution. For example, chemicals are dissolved directly to form complex. In the case of multiple salts, inorganic or organic acids can be first dissolved and then other chemicals that can form complex are dissolved. In another exemplary embodiment, an inorganic or organic acid or base or aqueous ammonia is used to adjust the product so that the pH of the final product is neutral. In a preferable embodiment, copper sulfate is first dissolved. Then aqueous ammonia is added to form complex. Then pH is adjusted to 6 to 10 with sodium hydroxide. In another preferable embodiment, copper chloride and humic acid are added to form solution. Then pH is adjusted to 6 to 10. It will be appreciated that the products of present invention are not in any way limited to liquid solution, but can be changed to a solid product or solid product in double package which can be conveniently formulated into solution when used. When using several kinds of salts and/or a larger amount of salt or making preparation under a low-temperature ambient, the resulted product can contain deposit, in which case an additional filtration step can be employed.

The present heat-transfer medium can be used in the field of heat production, especially in the heating field to replace a water medium. As the present heat-transfer medium has larger latent heat of evaporation than a water medium and has good heat conductivity and fast heat-transfer rate, the present heat-transfer medium can greatly save energy. In addition, the present heat-transfer medium is non-corrosive and can be used in existing pipelines and equipment.

The present invention is illustrated through the following examples, which only mean to illustrate, not to limit the scope of the invention.

### PREFERRED EMBODIMENTS OF CARRYING OUT THE INVENTION

### Example 1

11 g potassium sulfate, 5 g potassium chloride and 6 g copper nitrate were weighed and dissolved into 500 g water, heated to 60° C. 1 g humic acid was added. The mixture was adjusted to pH=7 using sodium hydroxide and water was added to a total amount of 1 kg. A product in a form of completely dissolved aqueous solution was obtained and characterized.

### Example 2

14 g of copper sulfate and 110 g of sodium nitrate were dissolved into 500 g water. 70 g magnesium chloride was added and 1 g humic acid was added. The mixture was adjusted to pH=8 using ammonium hydroxide and potassium hydroxide in a ratio of 1:1. Water was added to a total amount of 1 kg. A product in a form of completely dissolved aqueous solution was obtained. The corrosiveness and heat-transfer efficiency of the product were measured.

### Example 3

100 g copper nitrate, 200 g sodium di-hydrogen phosphate and 78 g potassium chloride were dissolved into 500 g water. 2 g propanetrioic acid was added. The mixture was heated to be completely dissolved and was adjusted to pH=9 using sodium hydroxide. Water was added to a total amount of 1 kg. A product in a form of completely dissolved aqueous solution was obtained after filtration.

### Example 4

25 g copper chloride and 1 g humic acid were weighed and heated to 60° C. After the mixture was dissolved completely, it was adjusted to pH=6 by using ammonium hydroxide. Water was added to a total amount of 1 kg. A product in a form of completely dissolved aqueous solution was obtained.

### Example 5

7 g copper sulfate, 8 g potassium chloride and 4.5 g zinc nitrate were weighed and dissolved into 500 g water. The mixture was heated to 40° C., then 0.5 g humic acid was added. The mixture was adjusted to pH=7 by adding sodium hydroxide, then water was added to a total amount of 1 kg to obtain a product in a form of completely dissolved aqueous solution. The product was characterized.

### Example 6

7 g copper nitrate, 6 g potassium chloride and 6.9 g zinc phosphate were weighed and dissolved into 500 g water. The mixture was heated to 60° C. Then 1 g humic acid was added. The mixture was adjusted to pH=7 using sodium hydroxide. Then water was added to a total amount of 1 kg. A product in a form of completely dissolved aqueous solution was obtained.

### Example 7

99 g potassium sulfate and 60 g sodium chloride and 40 g copper nitrate were dissolved into 500 g water. Then 1 g humic acid was added. The mixture was adjusted to pH=7 using sodium hydroxide and water was added to a total amount of 1 kg. A product in a form of completely dissolved aqueous solution was obtained. The product was characterized.

### Example 8

150 g potassium sulfate and 120 g potassium chloride and 80 g copper nitrate were dissolved into 500 g water. The mixture was heated to 60° C. and then 15 g humic acid and 30 g sodium hydroxyvalerate were added. The mixture was adjusted to pH=7 using sodium hydroxide and water was added to a total amount of 1 kg. After cooling and filtering, a product in a form of completely dissolved aqueous solution was obtained. The product was characterized.

### Example 9

5 g copper sulfate and 8 g sodium nitrate were dissolved into 500 g water. Then 2 g aqueous ammonia was added; 7 g magnesium chloride was added; and 1 g humic acid was added. The mixture was cooled to room temperature and a small amount of deposit was obtained. This was filtered to obtain a product in a form of completely dissolved aqueous solution. The product was characterized.

### Example 11

50 g copper nitrate, 110 g sodium di-hydrogen phosphate and 39 g zinc chloride were dissolved into 500 g water. The mixture was heated to 60° C. so that it was dissolved completely. Then 1 g humic acid was added. The mixture was adjusted to pH=7 using sodium hydroxide. Then water was added to a total amount of 1 kg. After filtering, a product in a form of completely dissolved aqueous solution was obtained. The product was characterized.

### Example 12

5 g copper nitrate, 11 g sodium di-hydrogen phosphate and 5 g potassium chloride were dissolved into 500 g water. The mixture was heated to 60° C. so that it was dissolved completely. Then 10 g sodium succinate was added and then 12 g humic acid was added. The mixture was adjusted to pH=7 using sodium hydroxide. Then water was added to a total amount of 1 kg. After cooling, and if there was deposit, filtering, a product in a form of completely dissolved aqueous solution was obtained. The product was characterized.

### Example 13

100 g zinc chloride and 90 g magnesium nitrate were dissolved into 500 g water. Then 10 g trisodium phosphate was added. The mixture was heated to 60° C. After the mixture was dissolved completely, it was adjusted to pH=7 using sodium hydroxide. Then water was added to a total amount of 1 kg. After filtering, a product in a form of completely dissolved aqueous solution was obtained. The product was characterized.

### Example 14

180 g zinc nitrate was dissolved into 500 g water. Then 20 g trisodium phosphate was added. The mixture was heated to 60° C. After the mixture was dissolved completely, it was adjusted to pH=7 using sodium hydroxide. Then water was added to a total amount of 1 kg. After filtering, a product in a form of completely dissolved aqueous solution was obtained. The product was characterized.

### Example 15

70 g copper sulfate and 80 g potassium chloride and 40 g zinc nitrate were dissolved into 500 g water. The mixture was heated to 60° C. Then 10 g humic acid was added. The mixture was adjusted to pH=7 using sodium hydroxide. Then water was added to a total amount of 1 kg. After cooling to room temperature, and if there was deposit, filtering, a product in a form of completely dissolved aqueous solution was obtained. The product was characterized.

### Example 16

140 g copper sulfate and 160 g potassium chloride and 99 g zinc nitrate were dissolved into 500 g water. The mixture was heated to 60° C. Then 1 g humic acid was added. The mixture was adjusted to pH=7 using sodium hydroxide. Then water was added to a total amount of 1 kg. A product in a form of completely dissolved aqueous solution was obtained after filtration. The product was characterized.

### Example 17

70 g copper nitrate, 60 g potassium chloride and 60 g zinc phosphate were dissolved into 500 g water. The mixture was heated to 40° C. Then 10 g humic acid was added. The mixture was adjusted to pH=7 using sodium hydroxide. Then water was added to a total amount of 1 kg. After cooling to room temperature, and if there was deposit, filtering, a product in a form of completely dissolved aqueous solution was obtained. The product was characterized.

### Example 18

100 g copper nitrate, 120 g potassium chloride and 120 g zinc phosphate were dissolved into 500 g water. The mixture was heated to 40° C. Then 10 g humic acid was added. The mixture was adjusted to pH=7 using sodium hydroxide. Then water was added to a total amount of 1 kg. After cooling to room temperature, and if there was deposit, filtering, a product in a form of completely dissolved aqueous solution was obtained. The product was characterized.

Tests of Characterization:

The present product was tested on heat conductivity, lifetime in use, and corrosiveness. Loss of medium was measured. Crack was examined by X-ray.

All measurements and tests were carried out according to common technology in the art. When heat conductivity was measured, a control test using a water medium was also performed at the same time. For example, temperatures at inlets and outlets of circulation systems, flow rate of cooling water and equilibrium time for the present medium and, the water medium were measured, respectively. The heat input was calculated according to the power input, and the heat absorbed by cooling water can be calculated to thus obtain the heat efficiency of system.

The lifetime of medium in use can be measured, such as by aging test, medium loss test and corrosion test.

Various devices can be used in the aging test. For example, a 4 mm hot-rolled steel plate can be used as an oven body. A one inch diameter seamless steel pipe can be connected externally in series with heat-releasing plate to form a heat generator, in which an amount of medium was then contained and heated such as by an electric oven. After heating the temperature of the oven body and of the medium at both ends were measured. Then the oven was heated continuously for 43,200 hours. The temperature at both ends were observed without any super-cooled or temperature fall phenomena. This demonstrated that the medium did not result in aging situation. The medium was weighed before and after heating. The residual medium within the oven body and pipelines was thoroughly vaporized, which changed to liquid by water cooling and flowed into weighing bottle and was weighed. The sum of the weighing result of residual medium and the amount of medium when it has been heated for 43,200 hours was compared with the amount of medium before it was heated.

The corrosion test was performed by dipping test materials ordinarily used in heat-producing system, including large and small nuts, steel plates, seamed steel pipes and seamless steel pipes, into the medium such as at a temperature of 90 to 95° C. for 43,200 hours. The weight loss for each sample was then measured. The result was converted to corrosion depth. In addition, the oven body of the heat transferor and the inner walls of pipelines were examined by using commercially available X-ray flaw-detector and the condition of metallic lattice was observed.

The measured results of heat-transfer efficiency were shown in table 1 below:

TABLE 1
Comparative Test for Heat-transfer Efficiency

| | | | | | | | | Heat | |
|---|---|---|---|---|---|---|---|---|---|
| | | | | Flow rate | | | | absorbed | |
| | Temperature of cooling water | | | of cooling | | Power | Heat | by cooling | Heat |
| | Ambient | Inlet | Outlet | water | Equilibrium | input | input | water | efficiency |
| | temperature | temperature | temperature | (kg/h) | time(s) | (kw) | (kcal) | (kcal) | of system |
| Water | 18.5° C. | 17° C. | 32.239° C. | 77.42° C. | 1800 | 3.146 | 1352.54 | 594.72 | 43.75 |
| medium | | | | | | | | | |
| The | 19° C. | 18.5° C. | 58.6° C. | 42.65° C. | 1200 | 2.256 | 646.604 | 560.988 | 87.68 |
| present | | | | | | | | | |
| medium | | | | | | | | | |

The results showed that the heat-transfer efficiency of the present medium was much higher than that of water medium. The present medium has greater latent heat of evaporation.

The results for aging test of the medium was obtained when no super-cooled or temperature fall phenomena appeared. The present medium did not result in aging.

The weight loss of medium was measured. The result indicated that the change in medium weight before and after heating was only 0.50 g. But the total amount of liquid which flowed into weighing bottle by evaporating the residual medium within the oven body and pipelines and then cooling was 0.49 g. This demonstrated that the weight loss of the medium was nearly zero.

Five corrosion tests were performed by dipping large and small nuts, steel plates, seamed steel pipes and seamless steel pipes into the present medium. The results of tests were shown in table 2 below.

TABLE 2
Weight Loss in Corrosive Dipping Test

| sample | weight before dipping(g) | weight after dipping(g) |
|---|---|---|
| 1 | 30.114 | 30.1110 |
| 2 | 60.1156 | 60.1151 |
| 3 | 54.1324 | 54.1316 |
| 4 | 465.6876 | 465.6870 |
| 5 | 369.6121 | 369.6116 |

Furthermore, the oven body and inner walls of pipes were examined by X-ray flaw-detector before and after heating. It was found that there was not any change to metallic lattice phase. This sufficiently demonstrated that the present heat-transfer medium was not corrosive.

The present heat-transfer medium can be used in the field of heat production, especially in the field of heat provision employing a medium other than water. As the present heat-transfer medium has great latent heat of evaporation, good heat conductivity and fast heat transfer rate, and does not produce scale or need auxiliary power, such as pump or auxiliary equipment such as those for softening water, the present medium system can avoid being frozen (hence be able to shut down or start up at any time in cold winter). Additionally or alternatively, the present medium system has no corrosion and can greatly save energy and reduce cost for operating the system. The present heat-transfer medium showed excellent features in the field of heat exchange (vapor-vapor, vapor-water or water-water), in the field of heat dispersion and the like. In particular, the viscosity, surface tension and heat conductivity co-efficiency of the present medium can be modulated within certain range, so it is much advantageous over the ordinary medium in heat distributor, heat exchanger of capillary structure. Moreover, as the present medium is not toxic or volatile and does not smell, burn or explode, the present medium can be used safely and reliably.

The present invention has been illustrated as above. It is clear that one skilled in the art can make many modifications and variations without departing the spirit and scope of the present invention.

What is claimed is:

1. A method for preparing a heat-transfer medium, comprising
dissolving one or more salts in water to form at least a coordination compound between metallic ions selected from copper, silver, gold, nickel, chromium, zinc and cobalt, and an organic or inorganic acid; and
adjusting the pH of the heat-transfer medium to be in the range of about 6 to 10.

2. The method according to claim 1, wherein the coordination compound comprises ammonia.

3. The method according to claim 1, wherein the pH of the heat-transfer medium is about 7.

4. The method according to claim 1, wherein the metallic salt comprises a salt of an inorganic or organic acid with an alkali or alkaline metal.

5. The method according to claim 1, wherein the inorganic acid comprises a hydrochloric, sulfuric, phosphoric, or nitric acid or a combination thereof.

6. The method according to claim 1, wherein the inorganic acid comprises a hydrochloric or phosphoric acid.

7. The method according to claim 1, wherein the organic acid comprises a humic acid, substituted or unsubstituted, a mono-carboxylic or poly-carboxylic acid having 1 to 6 carbon atoms, or a combination thereof.

8. The method according to claim 1, wherein the organic acid comprises a humic acid.

9. The method according to claim 2, wherein the content of the salt is at least 0.5 wt % but not more than 40 wt %.

10. The heat-transfer equipment which employs the heat-transfer medium according to claim 1.
